(19) United States
(12) Patent Application Publication
(10) Pub. No.: US 2007/0153257 A1
(43) Pub. Date: Jul. 5, 2007

(54) Optical Apparatus and Optical Measurement Method

(76) Inventor: Peng Chia Kuo, Taipei (TW)

Correspondence Address: LAW OFFICES OF LAI & ASSOCIATES, P.C., 5800 RANCHESTER, STE. 200, HOUSTON, TX, 77036, US

(21) Appl. No.: 11/306,611

(22) Filed: Jan. 4, 2006

(51) Int. Cl. G06K 9/74

(52) U.S. Cl. 356/71

(57) ABSTRACT

An optical apparatus comprises a light source, an optical sensing device and an optical element. The optical sensing device and the optical element are set at the same side. The optical element includes a reflector which is an arc. A light emitted by the light source can be reflected by the reflector of the optical element to the optical sensing device.

### FIELD OF THE INVENTION

The present invention relates to an optical apparatus and, more particularly, to integrate an optical element having a reflector with an arc for the optical apparatus and an optical measurement method.

### BACKGROUND OF THE INVENTION

Currently, a light emitting apparatus applied to the optical system often uses a point light source or a line light source especially for the fingerprint recognition apparatus. The scattered light emitted by the point light source or the line light source would cause non-uniformity and inconsistent directions. The bad image quality is produced when the point light source or the line light source is applied to the image sensing system. Referring to FIG. 1, a schematic diagram illustrates a conventional image sensing system. The image sensing system 10 comprises a point light source 11, a prism 12, a convex lens 13 and an image sensing device 14. A beam 111 emitted by the point light source 111 is reflected by the prism 12 to the convex lens 13 and is then concentrated to the image sensing device 14, hence an image which is near an incline of the prism 12 can be detected by the image sensing device 14 by way of above processes. However, the point light source may produce a scattered light without uniformity and the direction of the scattered light is inconsistent—the beam 112 for example. A blurred image may be detected by the image sensing device 14 that further influences an application for the next stage. Although a planar light source can be applied to emit a parallel beam with uniform intensity and consistent direction for replacing point light sources or line light sources to improve the image quality, the weaknesses of the planar light source are costly.

In addition, a distance must be set between the convex lens 13 and the image sensing device 14. Hence the beam can be concentrated by the convex lens 13 to the image sensing device 14 that restricts the range of scale down the image sensing system 10.

The inventor of the present invention based on years of experience on related research and development of the optical apparatus overcomes the shortcomings of the prior arts by integrating an optical element having a reflector with an arc for the optical apparatus and an optical measurement method.

### SUMMARY OF THE INVENTION

Accordingly, the object of the present invention is to provide an optical apparatus and an optical measurement method to improve the image sensing quality.

In accordance with the present invention the optical apparatus comprises a light source, an optical sensing device and an optical element. The optical sensing device and the optical element are set at the same side. The optical element has a reflector with an arc and a beam emitted by the light source is reflected by the reflector to the optical sensing device.

In addition, the present invention further provides an optical measurement method which comprises the steps of: Providing a light source and an optical sensing device, the light source and the optical sensing device are set at the same side; providing an optical element which has a reflector with an arc; emitting a beam from the light source and reflecting the beam to the optical sensing device through the reflector.

Other features and advantages of the present invention and variations thereof will become apparent from the following description, drawings, and claims.

### BRIEF DESCRIPTION OF THE DRAWINGS

FIG. 1 is a schematic diagram illustrating a conventional image sensing system;

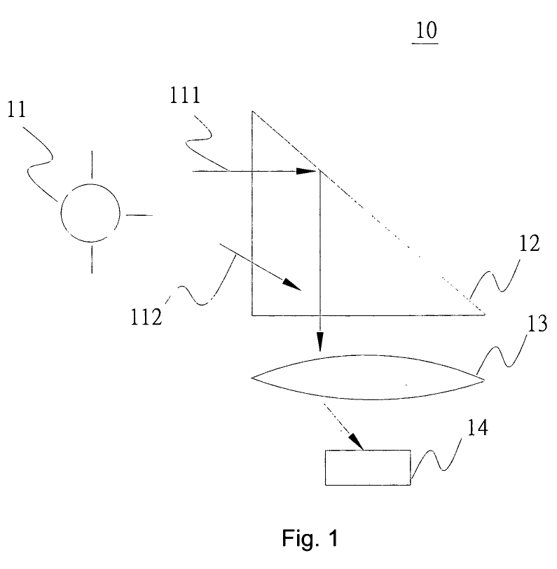

FIG. 2 is a schematic diagram illustrating an optical apparatus according to an embodiment of the present invention;

FIG. 3 is a schematic diagram illustrating an optical apparatus according to a preferred embodiment of the present invention;

FIG. 4 is a schematic diagram illustrating an optical apparatus according to another embodiment of the present invention;

FIG. 5 is a flowchart illustrating an optical measurement method according to an embodiment of the present invention; and

FIG. 6 is a flowchart illustrating an optical measurement method according to a preferred embodiment of the present invention.

### DETAILED DESCRIPTION OF THE PREFERRED EMBODIMENTS

To make it easier for understanding the objective of the invention, its innovative features and performance, a detailed description and technical characteristics of the power line communication system are described together with the drawings as follows.

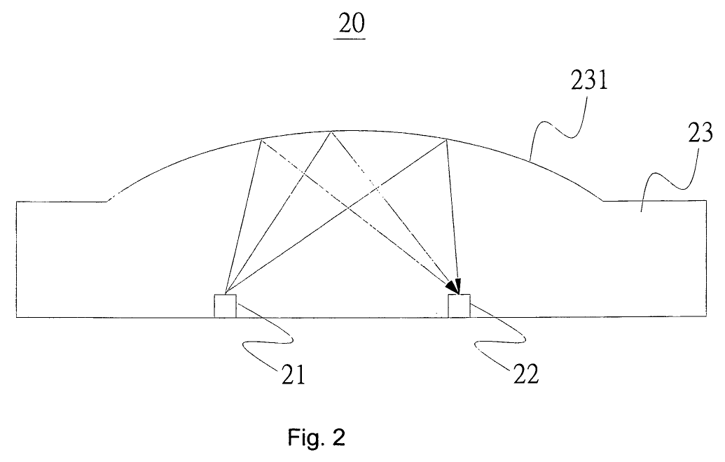

Referring to FIG. 2, a schematic diagram illustrates an optical apparatus according to an embodiment of the present invention. The optical apparatus 20 comprises a light source 21, an optical sensing device 22 and an optical element 23. The optical sensing device 22 and the light source 21 are set at the same side. The optical element 23 has a reflector 231. The reflector 231 is an arc and a light emitted by the light source 21 can be reflected by the reflector 231 to the optical sensing device 22. The light source 21 is a light emitting diode (LED), the optical sensing device 22 is a complementary metal oxide semiconductor (CMOS) element or a charge coupled device (CCD), the optical element 23 is a prism and the circular arc is a portion of an ellipse.

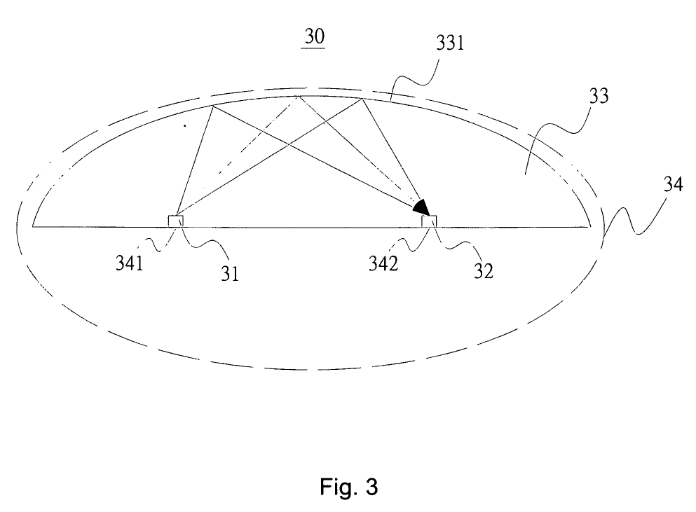

Referring to FIG. 3, a schematic diagram illustrates an optical apparatus according to a preferred embodiment of the present invention. The optical apparatus 30 comprises a light emitting diode (LED) 31, a charge coupled device (CCD) 32 and a prism 33. The LED 31 and the CCD 32 are set at the same side. The prism 33 has a reflector 331 and the reflector 331 is a half-arc of an ellipse 34. A light emitted by the LED 31 can be reflected by the reflector 331 to the CCD 32. The LED 31 is set at a focus 341 of the ellipse 34 and the CCD 32 is set at another focus 342 of the ellipse 34. As shown in FIG. 3, the ellipse 34 and the reflector 331 are separated to show and the reflector 331 in real practice is made based on the a half-arc of ellipse 34.

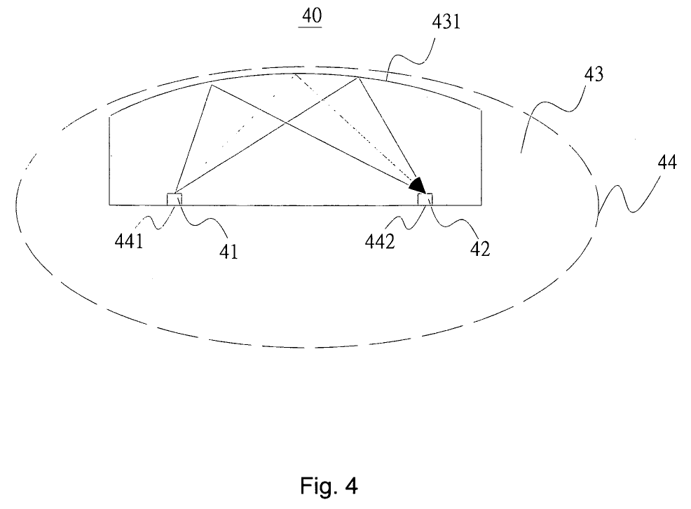

Referring to FIG. 4, a schematic diagram illustrates an optical apparatus according to another embodiment of the present invention. The optical apparatus 40 comprises a light emitting diode (LED) 41, a complementary metal oxide semiconductor (CMOS) element 42 and a prism 43. The LED 41 and the CMOS element 42 are set on the same side. The prism 43 has a reflector 431 and the reflector 431 is a portion of an ellipse 44. A light emitted by the LED 41 can be reflected by the reflector 431 to the CMOS element 42. The LED 41 is set at a focus 441 of the ellipse 44 and the CMOS element 42 is set at another focus 442 of the ellipse 44. As shown in FIG. 4, the ellipse 44 and the reflector 431 are separated to show and the reflector 431 in real practice is made based on a portion of the ellipse 44.

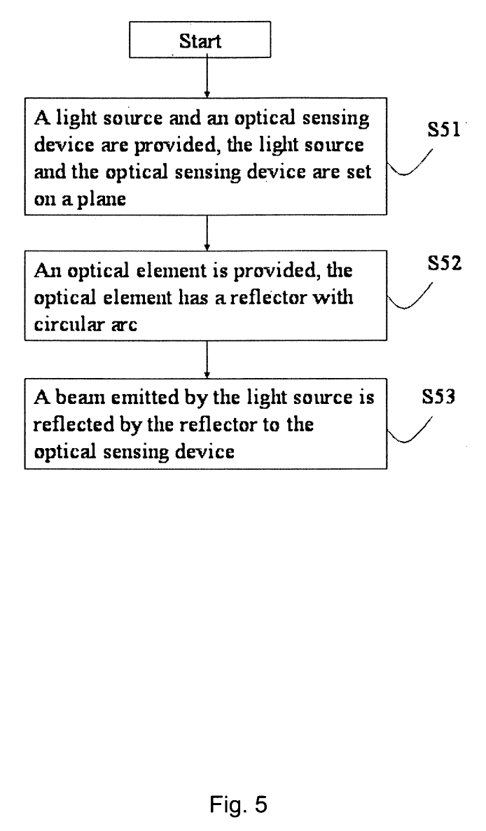

Referring to FIG. 5, a flowchart illustrates an optical measurement method according to an embodiment of the present invention. The method comprises the steps of: Step S51, a light source and an optical sensing device are provided, the light source and the optical sensing device are set on the same side. Next, step S52, an optical element is provided, the optical element has a reflector with an arc. Lastly, step S53, a beam emitted by the light source is reflected by the reflector to the optical sensing device. The light source is a light emitting diode (LED). The optical sensing device is a complementary metal oxide semiconductor (CMOS) element or a charge coupled device (CCD). The optical element is a prism. The circular arc is a portion of an ellipse.

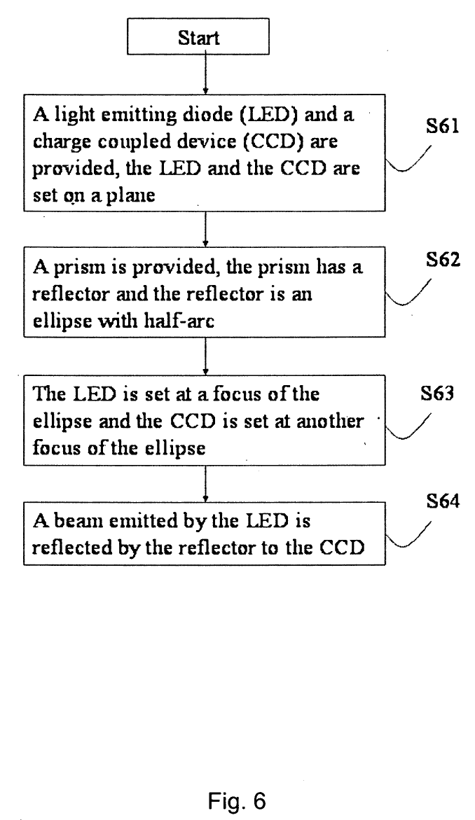

Referring to FIG. 6, a flowchart illustrates an optical measurement method according to a preferred embodiment of the present invention. The method comprises steps of: Step S61, a light emitting diode (LED) and a charge coupled device (CCD) are provided, the LED and the CCD are set on the same side. Next, step S62, a prism is provided, the prism has a reflector and the reflector is a half-arc of an ellipse. Step S63, the LED is set at a focus of the ellipse and the CCD is set at another focus of the ellipse. Lastly, step S64, a beam emitted by the LED is reflected by the reflector to the CCD.

Although the features and advantages of the embodiments according to the preferred invention are disclosed, it is not limited to the embodiments described above, but encompasses any and all modifications and changes within the spirit and scope of the following claims.

What is claimed is:

1. An optical apparatus, comprising:
a light source;
an optical sensing device, set on a side as same as said light source; and
an optical element having a reflector, wherein said reflector is an arc, a light emitted by said light source is reflected by said reflector to said optical sensing device.

2. The optical apparatus of claim 1, wherein said optical element is a prism.

3. The optical apparatus of claim 1, wherein said optical sensing device is a complementary metal oxide semiconductor (CMOS) element or a charge coupled device (CCD).

4. The optical apparatus of claim 1, wherein said circular arc is a portion of an ellipse.

5. The optical apparatus of claim 4, wherein said light source is set at a focus of said ellipse, said optical sensing device is set at another focus of said ellipse.

6. The optical apparatus of claim 1, wherein said reflector is set onto said light source and said optical sensing device.

7. An optical measurement method, comprising following steps:
providing a light source and an optical sensing device, said light source and said optical sensing device being set on the same side;
providing an optical element, said optical element having a reflector, said reflector being an arc; and
emitting a beam from said light source, reflecting said beam to said light sensing device through said reflector.

8. The optical measurement method of claim 7, wherein said optical element is a prism.

9. The optical measurement method of claim 7, wherein said optical sensing device is an image sensor.

10. The optical measurement method of claim 7, wherein said circular arc is a portion of an ellipse.

11. The optical measurement method of claim 10, wherein said light source is set at a focus of said ellipse and said optical sensing device is set at another focus of said ellipse.

12. The optical measurement method of claim 7, wherein said optical element is set upon said light source and said optical sensing device.
